(19) United States
(12) Patent Application Publication
(10) Pub. No.: US 2006/0039333 A1
(43) Pub. Date: Feb. 23, 2006

(54) Information handling system including wireless bandwidth management feature

(75) Inventors: Fahd Pirzada, Austin, TX (US); Liam B. Quinn, Austin, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 10/921,730

(22) Filed: Aug. 19, 2004

(51) Int. Cl. H04L 12/26

(52) U.S. Cl. 370/338; 370/229

(57) ABSTRACT

A wireless network is provided including a wireless access point (WAP) information handling system (IHS) that communicates with client IHSs via wireless information links. The WAP IHS determines the priority of a communication request from a client IHS and the link rate of that client IHS. The WAP IHS also determines the wireless network bandwidth that is available to the client IHS to carry out the requested communication. If the available network bandwidth is not greater than a threshold needed to assure a predetermined level of quality of service (QoS) for the requested communication, then countermeasures are engaged to free up network bandwidth.

### BACKGROUND

The disclosures herein relate generally to information handling systems (IHSs) and more particularly to transmitting information among multiple networked IHSs.

As the value and use of information continue to increase, individuals and businesses seek additional ways to process and store information. One option available to users is information handling systems. An information handling system (IHS) generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The demand on wireless local area networks (WLANs) for increased information throughput continues to grow. WLANs can be formed by one or more client IHSs wirelessly connected to another network, such as the Internet, by a wireless access point (WAP). The WAP may be called on to service multiple data streams, for example multimedia streams such as video streams and audio streams, wherein some streams are faster than others. In this situation it is possible that the faster client IHS may have to wait for the slower client IHS to send its information. This can result in unacceptable quality of service (QoS) in multimedia WLANs which transmit data intensive streams such as multimedia data streams.

What is needed is a network system and method of operation without the deficiencies described above.

### SUMMARY

Accordingly, in one embodiment, a method is disclosed for operating a wireless network (IHS) including receiving a request to communicate from a wireless client IHS. The method also includes determining a priority class of the request. The method further includes determining an available wireless bandwidth related to the priority class of the request and a link speed of the request. The method still further includes determining if the available wireless bandwidth exceeds a predetermined threshold and initiating countermeasures if the available wireless bandwidth fails to exceed the predetermined threshold.

In another embodiment, a wireless network IHS is disclosed which includes a transceiver that transmits and receives wireless communications. The transceiver is configured to receive a request to communicate from a wireless client IHS. The wireless network also includes a bandwidth manager that is responsive to the transceiver. The bandwidth manager determines a priority class of the request. The bandwidth manager also determines an available wireless bandwidth related to the priority class of the request and a link speed of the request. The bandwidth manager also determines if the available wireless bandwidth exceeds a predetermined threshold and initiates countermeasures if the available wireless bandwidth fails to exceed the predetermined threshold.

A principal advantage of one or more of the embodiments disclosed herein is improved quality of service to client IHSs in a wireless network system.

### BRIEF DESCRIPTION OF THE DRAWINGS

FIG. 1 is a high level block diagram of the disclosed network system.

FIG. 2 is a block diagram of a representative IHS employed in the disclosed network system.

FIG. 3 is a flowchart depicting the operation of a wireless access point IHS in the disclosed network system.

FIG. 4 is a flowchart depicting the operation of a client IHS in the disclosed network system.

### DETAILED DESCRIPTION

Quality of Service (QoS) is a significant concern when data intensive multimedia information is streamed over a wireless local area network (WLAN). It is possible that a plurality of multimedia information streams can overwhelm a WLAN. As more streams are added to a particular WLAN, the likelihood increases that some steams will suffer QoS problems. A slow stream may consume so much time that the QoS of a faster stream is negatively impacted.

The recent IEEE 802.11e standard provides a supplementary media access control (MAC) layer that enables QoS for LAN applications. The IEEE 802.11e standard defines managed levels of QoS for data, voice and video such that audio/video streams (i.e. multimedia information streams) get higher priority than normal less intensive data. QoS is very important for multimedia information streams such as video and audio. A slow frame in a video sequence may be readily perceived by a viewer as a disturbance or artifact in the video image. Likewise, a gap during audio playback may be very objectionable to the listener. In contrast, if normal less intensive data such as an email message arrives in 10 seconds instead of 5 seconds, the recipient will likely not object or even be aware of the delay. QoS is thus seen to be less important with respect to transmission of regular data associated with non-multimedia or background tasks.

An example is useful to illustrate QoS problems that may be encountered when plural multimedia information streams are serviced on a WLAN. In one scenario a wireless access point (WAP) is being used to service two video streams encoded at 6 Mbps over an IEEE 801.11g home network. In practice the 802.11g protocol provides an actual throughput of approximately 20+Mbps when a client IHS is connected at the maximum speed of 54 Mbps. In theory, with QoS support, the IEEE 802.11g network should be able to support two 6 Mbps video streams that are requested by two different client IHSs in the WLAN. However, when one of the client IHSs is moved further and further away from a wireless access point (WAP) IHS, the protocol automatically scales back the link speed to progressively lower data rates, for example, from 36, to 24 to 12 Mbps. When mobile clients such as in this scenario operate at data rates less than the 54 Mbps limit, a faster client IHS must share time with a slower client IHS. Thus, the overall network throughput falls below an optimal 20 Mbps. In this scenario, even prioritized video streams fall short of the required QoS. While IEEE 802.11e currently helps to provide a higher QoS for multimedia streams by prioritizing these streams, network congestion still exists due to multiple audio/video streams competing for the same limited bandwidth.

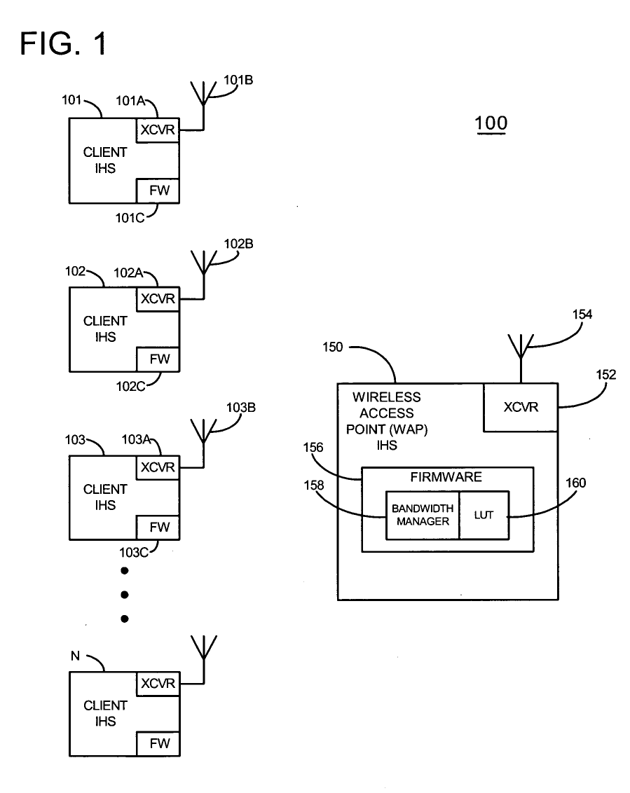

FIG. 1 is a block diagram of an illustrative disclosed network 100 including client IHSs 101, 102, 103, . . . N which are wirelessly connected to a wireless access point (WAP) IHS 150. N is the total number of client IHSs in network 100. For purposes of this disclosure, an information handling system (IHS) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a video display, a keyboard, a mouse, voice inputs and other human interface devices (HIDs). The information handling system may also include one or more buses operable to transmit communications between the various hardware components.

Client IHS 101 is representative of the client IHSs of FIG. 1. Client IHS 101 includes a wireless transceiver (XCVR) 101A coupled to an antenna 101B. Client IHS 101 also includes firmware 101C that governs the overall operation of the client IHS.

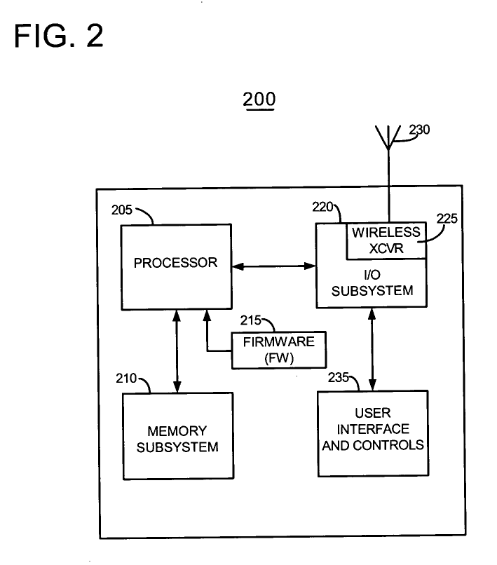

FIG. 2 is a block diagram of an information handling system (IHS) 200 that may be employed as client IHSs 101, 102, 103 . . . N. Client IHSs 101, 102, 103 . . . N can take many different forms. For example, the client IHSs may be a notebook computer, laptop computer, tablet device, handheld device, personal digital assistant (PDA) or other IHS with wireless communication capability. The client IHSs may also take the form of embedded systems such as a television, set top box, media device, phone or other wireless IHS device. In the particular embodiment illustrated in FIG. 2, IHS 200 includes a processor 205 such as an Intel Pentium series processor, an Advanced Micro Devices (AMD) processor or one of many other processors currently available. A memory subsystem 210 is coupled to processor 205 to provide storage for the IHS to facilitate the execution of program applications by the IHS. IHS 200 includes firmware 215 that governs the overall operation of the IHS. Firmware 215 can be stored in nonvolatile memory. An I/O subsystem 220 is coupled to processor 205 to handle input-output activities of the IHS. The I/O subsystem 220 includes a wireless transceiver (XCVR) 225 which is coupled to an antenna 230 to enable IHS 200 to transmit and receive wireless signals. In one embodiment, wireless transceiver 225 is compatible with the IEEE 802.11 series of wireless standards, for example the IEEE 802.11e wireless signaling protocol. IHS 200 includes a user interface and controls 235 so that the user may interact with the IHS. For example, the user interface and controls 235 may include a display which the user can view, a keyboard and/or mouse with which the user can provide input, and other input and output devices that enable the user to interact with the IHS.

Wireless access point (WAP) 150 is also a type of information handling system or IHS. IHS 200 of FIG. 2 can be configured to operate as wireless access point (WAP) IHS 150 of FIG. 1. WAP IHS 150 includes a transceiver 152 which is coupled to an antenna 154 to enable WAP IHS 150 to transmit and receive communications with client IHSs as seen in FIG. 1. Firmware 156 of WAP IHS 150 corresponds to firmware 215 of the IHS 200 of FIG. 2. Firmware 156 is configured to enable WAP IHS 150 to: 1) monitor the priority class of information flowing though network system 100; 2) monitor connection speeds of the client IHSs that are requesting high priority multimedia content; 3) determine the effective bandwidth utilization of network system 100 based on the determined connection speeds of the client IHSs that request high priority multimedia content; 4) trigger countermeasures when the effective network bandwidth utilization falls below a predetermined threshold; and 5) adjust the countermeasures to obtain improved quality of service (QoS). In actual practice, a bandwidth manager application 158 stored in firmware 156 carries out the tasks described above. Quality of service refers to the performance specification of a communication channel or system. QoS performance is indicated by objective parameters such as signal to noise ratio, bit error ratio, message throughput rate and the number of interruptions or gaps in a transmission intended to be perceived by the user as being continuous. The QoS for a certain application may be thought of as the lack of jitter, latency or dropped frames etc. depending on the type of application and the desired level of service.

The bandwidth manager application 158 in firmware 156 allocates bandwidth to selected client IHSs based on the respective speeds of the links formed between WAP IHS 150 and client IHSs 101, 102, 103 . . . N. Multimedia streams such as video and audio streams are prioritized ahead of regular or normal data streams. Faster client IHSs are prioritized ahead of slower IHSs to lessen the degrading effect of slower client IHSs on network performance. It is noted that the speed of a particular client IHS can be dynamic over time. For example, as a client IHS moves further away from a wireless access point (WAP), the wireless access point scales back the speed of that client's connection to the wireless access point. As the speed of this client IHS falls with respect to other client IHSs, the other faster IHSs will be now be prioritized ahead of the now slower client IHS to reduce the negative impact of the now slower client IHS on network performance. The WAP IHS 150 and the bandwidth manager 158 in it is firmware 156 thus adapt as the speeds of client IHSs vary.

Since all client IHSs are wirelessly coupled to WAP IHS 150, WAP IHS 150 has knowledge of the current link rate of each client IHS and the priority level or class requested by each client IHS. The link rate is the data rate for a certain wireless link as specified, for example, by the 802.11g standard as 54, 36, 24, 18, 12 and 6 Mbps, typically in Mbps, between a particular client IHS and the WAP IHS. The bandwidth manager application 158 in the firmware of WAP IHS 150 dynamically allocates wireless bandwidth based on the link rates and requested prioritization class of the respective client IHSs. Using the prioritization class or level of each client IHS and the current link rate of that IHS, the effective bandwidth utilization of the wireless network coupled to the WAP IHS is determined by the WAP IHS. The bandwidth manager 158 determines the effective bandwidth utilization by adding the bandwidth utilization of the respective client IHSs together including the bandwidth utilization of the most recent client IHS to request high priority bandwidth allocation, such as is appropriate for streaming audio and streaming video. Using this information, the bandwidth manager determines the bandwidth that is available for the particular client IHS that is requesting communication. If the available bandwidth that can be assigned to the requesting client IHS fails to exceed a predetermined threshold, then it is determined that the wireless network would be too congested and one or more countermeasures are initiated. Countermeasures include for example 1) changing a particular client IHS to a lower data link rate; 2) ceasing transmission of a particular client IHS, 3) lowering the priority class of one or more client IHSs and 4) changing the wireless transmission parameters such as contention windows size (CW) or arbitration inter frame space (AIFS). Each of these countermeasures frees up bandwidth on the wireless network. Other countermeasures that free up wireless network bandwidth, for example buffering, may be used as well.

An example will be helpful at this point to illustrate the operation of one embodiment of the disclosed network system 100. Three scenarios are referenced as shown in TABLE 1 below. It is noted that the bandwidth manager application 158 can be enabled or disabled as desired. Once the bandwidth manager application 158 is enabled, it determines the effective bandwidth utilization in real time as shown in the scenarios of TABLE 1. For this discussion it is assumed that two 6 Mbps video streams are being serviced by client A and client B respectively.

TABLE 1

| | | | | INDIV. | INDIV. |
|---|---|---|---|---|---|
| | | | AVAILABLE | CLIENT | CLIENT |
| | CLIENT A | CLIENT B | NETWORK | THRU-PUT | THRU-PUT |
| | SPEED | SPEED | THRU-PUT | CLIENT A | CLIENT B |
| SCENARIO | 54 Mbps | 54 Mbps | 25 Mbps | 12.5 Mbps | 12.5 Mbps |
| 1 | | | | | |
| SCENARIO | 12 Mbps | 12 Mbps | 6 Mbps | 3 Mbps | 3 Mbps |
| 2 | | | | | |
| SCENARIO | 54 Mbps | 12 Mbps | 9 Mbps | 4.5 Mbps | 4.5 Mbps |
| 3 | | | | | |

In scenario 1, the speed of client A and client B is 54 Mbps while the network throughput is 25 Mbps. The network throughput is split in half between contending clients A and B, each being allocated 12.5 Mbps of bandwidth. The available bandwidth is sufficient to enable clients A and B to service respective 6 Mbps video streams. Since the bandwidth requested by a client such as client A (6 Mbps) is less that the 12.5 Mbps bandwidth that is available to client A, no countermeasures are initiated. Client A is able to service the 6 Mbps video stream without negatively impacting QoS as is Client B.

In scenario 2, the speed of client A and client B is 12 Mbps while the network throughput is 6 Mbps. The network throughput is again split in half between contending client A and B, each being allocated 3 Mbps of bandwidth. In this scenario, the bandwidth manager application 158 determines that the bandwidth available for allocation to each client has fallen below the 6 Mbps threshold necessary for video QoS. In response to this condition, the bandwidth manager application 158 initiates countermeasures, as described above, to free up network bandwidth. The countermeasures may include denial of service to a slower client IHS or buffering to support the high bandwidth video stream, for example.

In scenario 3, the speed of client A is 54 Mbps and the speed of client B is 12 Mbps while the network throughput is 9 Mbps. The network throughput is again split in half between contending client A and B, each being allocated 4.5 Mbps of bandwidth. In this scenario, the bandwidth manager application 158 again determines that the bandwidth available for allocation to each client has fallen below the 6 Mbps threshold necessary for video QoS. In response to this condition, the bandwidth manager application 158 initiates countermeasures, as described above, to free up network bandwidth.

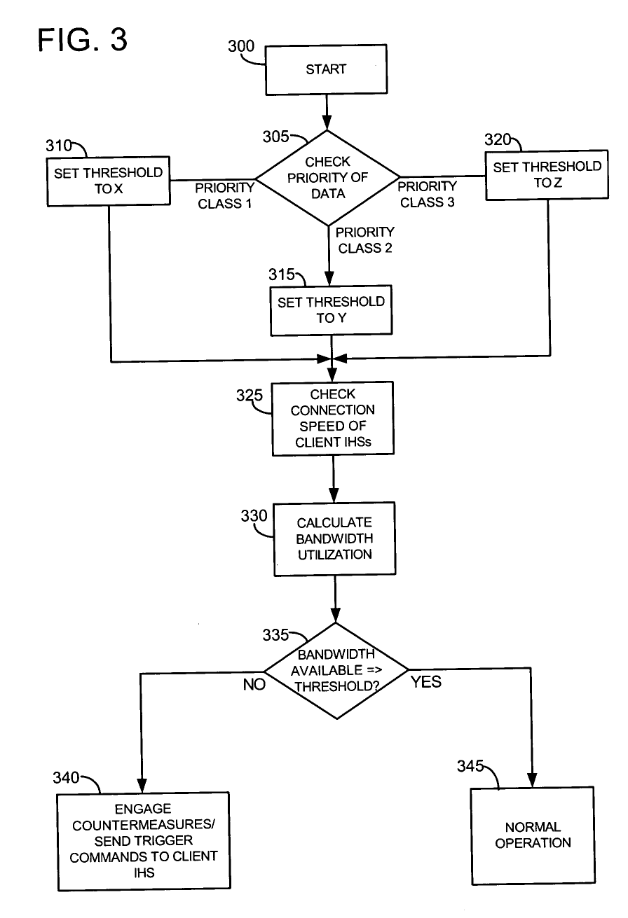

FIG. 3 is a flowchart showing the operation of the bandwidth manager application 158 in firmware 156 in WAP IHS 150. The bandwidth manager application starts operation at start block 300. The priority class of a particular request for information transmission by a client IHS is checked at decision block 305. Different types of information are assigned different priority classes according to their need for QoS. Requests for transmission of audio information have a higher priority class than requests for transmission of video information which is less latency sensitive. Requests for transmission or regular data, for example, email, word processing documents and spreadsheets, have a lower priority class than video or audio information requests because such regular data requests are less bandwidth intensive. For purposes of this particular example, audio information requests are assigned priority class 1, video information requests are assigned priority class 2 and regular data requests such as for background task information are assigned priority class 3. The priority class of a particular information request may be included in header information within the request.

If the priority class of a particular information transmission request is found to be priority class 1, i.e. audio information, then a threshold is set to a value, X, as per block 310. If the priority class of information transmission request is found to be priority class 2, i.e. video information, then the threshold is set to a value Y, as per block 315. If the priority class of an information transmission request is found to be priority class 3, i.e. regular data, then the threshold is set to a value Z, as per block 320. The threshold is set to a value appropriate to assure QoS for the particular type of information request. The threshold represents the minimum bandwidth needed to communicate with an acceptable level of QoS for the particular requested communication. Audio information requests are assigned a higher threshold than video information requests or regular data requests to assure that acceptable QoS is achieved for the requested type of communication. Video information requests are assigned a lower threshold than audio information requests, but receive a higher threshold than regular data requests.

The connection speeds of the client IHSs are then checked by WAP IHS 150 at block 325. WAP IHS 150 then determines the total effective bandwidth utilization that would result from the current information transmission request if serviced along with the other client IHSs which are consuming bandwidth as per block 330. More particularly, the bandwidth utilization needed to carry out the particular current information transmission request from the client IHS is determined. This bandwidth utilization determines the bandwidth available for the client IHS making the current information transmission request. A test is then conducted at decision block 335 to determine if the bandwidth available to the client IHS to carry out the current information request exceeds the threshold assigned to that client IHS for the request. The threshold represents the minimum bandwidth needed to carry out this particular priority class of communication request at a QoS acceptable for this class. If it is found that the bandwidth available to the client IHS making the current information request does not equal or exceed the threshold corresponding to that request, then countermeasures are engaged to free up wireless network bandwidth as per block 340. For example, the WAP IHS 150 sends a trigger command to one or more client IHSs instructing the client IHSs to scale back data transmission speed or to cease transmission. However, if the available bandwidth equals or exceeds the threshold, then normal operation continues as per block 345 wherein the current information request is serviced using available bandwidth.

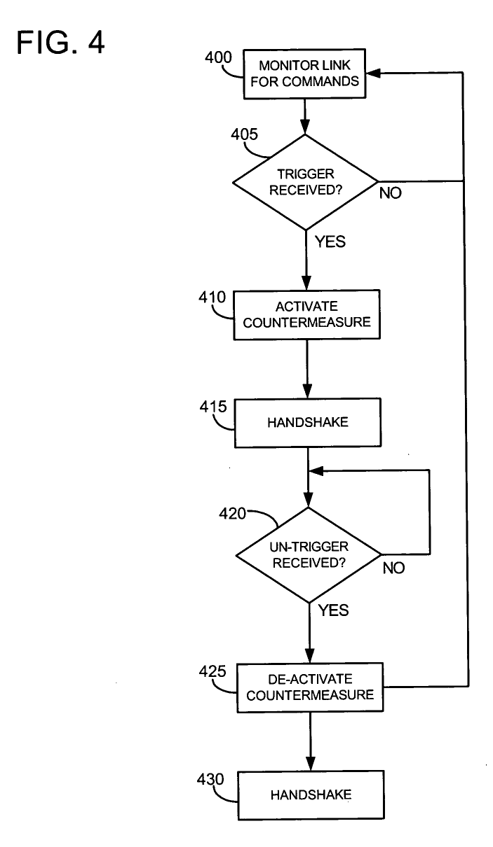

FIG. 4 is a flowchart depicting the operation of a client IHS in wireless network 100. For example, client IHS 101 includes firmware (FW) 101C that controls the operational flow of the client IHS in the manner depicted in the flow chart of FIG. 4. Client IHS 101 monitors its wireless link with WAP IHS 150 for commands from WAP IHS 150, as per block 400. Client IHS 101 tests to see if a countermeasure trigger has been received over the link as per block 405. If no countermeasure trigger command is received, then client IHS 150 continues monitoring for countermeasure trigger commands. When client IHS 101 does receive a trigger command from WAP IHS 150, then client IHS 101 activates the particular type of countermeasure specified by the trigger command, as per block 410. For example, if client IHS 101 receives a trigger command to scale back its link rate, then client IHS 101 reduces the speed of wireless transmission on its link with WAP IHS 150. Similarly, if client IHS 101 receives a trigger command to cease transmission, then it ceases transmission for a predetermined amount of time, thus freeing up bandwidth. When the countermeasure is engaged, client IHS 101 conducts a handshake operation with WAP IHS 150 to confirm that the countermeasure was implemented, as per block 415. It is possible that client IHS 101 may object to and ignore the trigger command. If this occurs, the WAP IHS 150 is so notified in the handshake. After the countermeasure is implemented, client IHS 101 monitors its data link with WAP IHS 150 to determine if an un-trigger countermeasure command is received, as per decision block 420. When an un-trigger countermeasure command is received, the earlier implemented countermeasure is deactivated as per block 425. A handshake operation is then conducted between client IHS 101 and WAP IHS 150 to confirm that the countermeasure has been deactivated, as per block 430.

Firmware 156 in WAP IHS 150 may include a look-up table (LUT) 160 to facilitate determination of the appropriate threshold for a particular request to communicate information from a client IHS. One representative look-up table that may be employed in LUT 160 is shown in TABLE 2 below. This particular example is for video traffic and shows how the threshold can vary with different link rates.

TABLE 2

| | | Link Rate | |
|---|---|---|---|
| Traffic Type | Priority Class | (Mbps) | Threshold |
| Video | 4 or 5 | 1 | 378 |
| | | (802.11 b) | |
| Video | 4 or 5 | 2 | 378 |
| | | (802.11 b) | |
| Video | 4 or 5 | 6 | 378 |
| | | (802.11 g/a) | |
| Video | 4 or 5 | 12 | 192 |
| | | (802.11 g/a) | |
| Video | 4 or 5 | 18 | 144 |
| | | (802.11 g/a) | |
| Video | 4 or 5 | 24 | 96 |
| | | (802.11 g/a) | |
| Video | 4 or 5 | 36 | 36 |
| | | (802.11 g/a) | |
| Video | 4 or 5 | 54 | 5 |
| | | (802.11 g/a) | |

It is noted that in actual practice the threshold for a particular communication request is set based on traffic already flowing through WAP IHS 150, rather than the type of new request coming into WAP IHS 150. For example, if three 6 Mbps video streams are already being serviced by the WAP IHS 150, then the threshold will be much higher. WAP IHS 150 considers the number of clients, their link rates and then assigns the threshold based on the amount of high priority traffic originating from these clients. This means that, in this particular embodiment, a stream of traffic will need a very high priority and a good link rate to be able to get above the threshold. It should be appreciated that the threshold is not a fixed value, but rather is a value that changes with the current level of congestion.

TABLE 3A is a look up table that shows weighted link rates values (V) varying with different priority classes (priorities). TABLE 3B is a look up table that shows weighted link rates values (V) varying with different link rates for a particular representative traffic type, namely video in this particular example. In TABLE 3A and 3B, the weight link rate value V is determined by the equation, V=link rate*(1+priority).

TABLE 3A

| | | | Weighted |
|---|---|---|---|
| | | | Link Rate |
| | Priority | Link Rate | Value |
| Traffic Type | Class | (Mbps) | (V) |
| Background | 0 | 24 | 48 |
| | | (802.11 g/a) | |
| Background | 1 | 24 | 48 |
| | | (802.11 g/a) | |
| Best Effort | 2 | 24 | 96 |
| | | (802.11 g/a) | |
| Best Effort | 3 | 24 | 96 |
| | | (802.11 g/a) | |
| Video | 4 | 24 | 144 |
| | | (802.11 g/a) | |
| Video | 5 | 24 | 144 |
| | | (802.11 g/a) | |
| Audio | 6 | 24 | 192 |
| | | (802.11 g/a) | |
| Audio | 7 | 24 | 192 |
| | | (802.11 g/a) | |

TABLE 3B

| | | | Weighted |
|---|---|---|---|
| | | Link Rate | Link Rate |
| Traffic Type | Priority Class | (Mbps) | (V) |
| Video | 4 or 5 | 1 | 6 |
| | | (802.11 b) | |
| Video | 4 or 5 | 2 | 12 |
| | | (802.11 b) | |
| Video | 4 or 5 | 6 | 36 |
| | | (802.11 g/a) | |
| Video | 4 or 5 | 12 | 72 |
| | | (802.11 g/a) | |
| Video | 4 or 5 | 18 | 108 |
| | | (802.11 g/a) | |
| Video | 4 or 5 | 24 | 144 |
| | | (802.11 g/a) | |
| Video | 4 or 5 | 36 | 216 |
| | | (802.11 g/a) | |
| Video | 4 or 5 | 54 | 324 |
| | | (802.11 g/a) | |

For any new stream to be handled by WAP IHS 150, that new stream, is assigned a number V, namely the weighted link rate, that is based on the link rate and the priority class. The weighted link rate number V can be calculated, for example, by multiplying the link rate by the priority class [V=Link rate*(1+priority class)]. The number V is thus a weighted representation of the link rate and is related to the bandwidth that is presently available for usage by WAP IHS 150. This weighted link rate number V is compared to the current threshold in a manner similar to that indicated in decision block 335 of FIG. 3. If the threshold is higher than V, then countermeasures are activated in order to service the new stream. Otherwise, countermeasures are not activated and normal operation continues. The lookup tables, namely TABLES 3A and 3B, define representative weighted link rate values V as described above. For any new stream, the WAP IHS 150 considers the link rate requested for that stream, the priority class of the stream, and look up TABLES 3A and 3B provides the weighted link rate value V as described. The weighted link rate value V is compared with the current threshold. Again, if the threshold exceeds the weighted link rate V, then countermeasures are activated to enable the service request to be handled. Stated alternatively, if the weighed link rate is less than the threshold, then countermeasures are engaged. Otherwise, normal operation continues without countermeasures in one embodiment. It is noted that once countermeasures are engaged, the weighted link rate number V may change and become higher than the threshold and then it may be possible to service the stream.

Referring again to TABLE 2 (showing threshold values) and TABLE 3A, 3B (showing weighted link rates, V), it is noted that the calculation of the threshold and the value V will be independent of each other. The value of the threshold is determined based on the number of streams with a certain priority class and data rate. For each new stream, the value of V will be calculated based on the priority class and data rate of the client requesting the bandwidth. TABLE 2 shows that a priority class has different values of threshold depending on the data rate. It will be recalled that in TABLE 2 video was the video traffic type and thus the priority was 4 or 5. However, if the data rate is lower, the network has to use more resources to service the request and therefore the threshold is higher. If the priority class is lower, for the same data rate, the threshold will be set at a lower value. Similarly if the priority class is higher then the threshold will be higher. The variation of threshold with different priority classes (priorities) is illustrated in TABLE 4 below:

TABLE 4

| | | Link Rate | |
|---|---|---|---|
| Traffic Type | Priority Class | (Mbps) | Threshold |
| Background | 0 | 54 | 5 |
| | | (802.11 g/a) | |
| Background | 1 | 54 | 5 |
| | | (802.11 g/a) | |
| Best Effort | 2 | 54 | 54 |
| | | (802.11 g/a) | |
| Best Effort | 3 | 54 | 54 |
| | | (802.11 g/a) | |
| Video | 4 | 54 | 270 |
| | | (802.11 g/a) | |
| Video | 5 | 54 | 270 |
| | | (802.11 g/a) | |
| Audio | 6 | 54 | 378 |
| | | (802.11 g/a) | |
| Audio | 7 | 54 | 378 |
| | | (802.11 g/a) | |

It is also noted that in actual practice, the ultimate threshold employed will vary with the number of streams to be serviced. For example, as shown in TABLE 5, the threshold increases as the number of streams increases.

TABLE 5

| Traffic | No. of | Priority | Link Rate | |
|---|---|---|---|---|
| Type | Streams | Class | (Mbps) | Threshold |
| Video | 1 | 4 or 5 | 24 | 96 |
| | | | (802.11 g/a) | |
| Video | 2 | 4 or 5 | 24 | 192 |
| | | | (802.11 g/a) | |
| Video | 3 | 4 or 5 | 24 | 384 |
| | | | (802.11 g/a) | |

The disclosed methodology and apparatus provides quality of service to wireless network clients having variable link rates.

Although illustrative embodiments have been shown and described, a wide range of modification, change and substitution is contemplated in the foregoing disclosure and in some instances, some features of an embodiment may be employed without a corresponding use of other features. Accordingly, it is appropriate that the appended claims be construed broadly and in manner consistent with the scope of the embodiments disclosed herein.

What is claimed is:

1. A method of operating a wireless network (IHS) comprising:
receiving a request to communicate from a wireless client IHS;
determining a priority class of the request;
determining an available wireless bandwidth related to the priority class of the request and a link speed of the request;
determining if the available wireless bandwidth exceeds a predetermined threshold; and
initiating countermeasures if the available wireless bandwidth fails to exceed the predetermined threshold.

2. The method of claim 1 wherein the wireless network IHS is a wireless access point (WAP) IHS.

3. The method of claim 1 wherein link speed is variable.

4. The method of claim 1 wherein the priority class indicates that the client IHS is requesting video communication.

5. The method of claim 1 wherein the priority class indicates that the client IHS is requesting audio communication.

6. The method of claim 1 wherein the priority class indicates that the client IHS is requesting normal data communication.

7. The method of claim 1 wherein the countermeasures include scaling back the link speed of a client IHS communicating with the wireless network IHS.

8. The method of claim 1 wherein the countermeasures include denying service to a client IHS communicating with the wireless network IHS.

9. The method of claim 1 wherein the countermeasures include buffering information by a client IHS.

10. The method of claim 1 wherein the countermeasures include lowering the priority class of a client IHS communicating with the wireless network IHS.

11. A wireless network (IHS) comprising:
a transceiver that transmits and receives wireless communications, the transceiver being configured to receive a request to communicate from a wireless client IHS;
a bandwidth manager, responsive to the transceiver, the bandwidth manager being configured to:
determine a priority class of the request;
determine an available wireless bandwidth related to the priority class of the request and a link speed of the request;
determine if the available wireless bandwidth exceeds a predetermined threshold; and
initiate countermeasures if the available wireless bandwidth fails to exceed the predetermined threshold.

12. The wireless network (IHS) of claim 11 wherein the wireless network IHS is a wireless access point (WAP) IHS.

13. The wireless network (IHS) of claim 11 wherein link speed is variable.

14. The wireless network (IHS) of claim 11 wherein the priority class indicates that the client IHS is requesting video communication.

15. The wireless network (IHS) of claim 11 wherein the priority class indicates that the client IHS is requesting audio communication.

16. The wireless network (IHS) of claim 11 wherein the priority class indicates that the client IHS is requesting normal data communication.

17. The wireless network (IHS) of claim 11 wherein the countermeasures include scaling back the link speed of a client IHS communicating with the wireless network IHS.

18. The wireless network (IHS) of claim 11 wherein the countermeasures include denying service to a client IHS communicating with the wireless network IHS.

19. The wireless network (IHS) of claim 11 wherein the countermeasures include buffering information by a client IHS.

20. The wireless network (IHS) of claim 11 wherein the countermeasures include lowering the priority class of a client IHS communicating with the wireless network IHS.
